(19) United States
(12) Patent Application Publication
(10) Pub. No.: US 2026/0313474 A1
(43) Pub. Date: Oct. 8, 2026

(54) CELLULAR NETWORK ARCHITECTURE WITH GATEWAY NODE ACTING AS A HUB

(71) Applicant: JIO PLATFORMS LIMITED, Ahmedabad (IN)

(72) Inventors: Satish JAMADAGNI, Bangalore (IN); Mahesh NAYAKA MYSORE ANNAIAH, Bengaluru (IN); Pradeep HIRISAVE, Bengaluru (IN); Mathew OOMMEN, Plano, TX (US)

(73) Assignee: JIO PLATFORMS LIMITED, Ahmedabad (IN)

(21) Appl. No.: 19/478,882

(22) PCT Filed: Apr. 22, 2024
(86) PCT No.: PCT/IB2024/053899

§ 371 Date: Oct. 27, 2025

(30) Foreign Application Priority Data
Apr. 29, 2023 (IN) 202321030831

(51) Int. Cl. H04W 36/00; H04W 8/22; H04W 88/16

(52) U.S. Cl. CPC H04W 36/0033; H04W 8/22; H04W 88/16

(57) ABSTRACT

A cellular network architecture with a gateway node (308) acting as a hub is disclosed. The gateway node (308) deter-mines a unique User Equipment (UE) context of a UE (312) for each of a first coverage state and a second coverage state of the UE (312). The gateway node (308) dynamically saves the unique UE context. Further, the gateway node (308) shares a paging message with a Core Network (CN) (304). The unique UE context may be saved at the CN (304) to provide a seamless mobility service to the UE (312).

A portion of the disclosure of this patent document contains material which is subject to intellectual property rights such as, but are not limited to, copyright, design, trademark, Integrated Circuit (IC) layout design, and/or trade dress protection, belonging to Jio Platforms Limited (JPL) or its affiliates (herein after referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### TECHNICAL FIELD

The present disclosure relates to the field of wireless networks, and specifically to a method and an apparatus for providing a cellular network architecture where a gateway acts as a hub.

### BACKGROUND

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art. Current Fifth Generation (5G) communication technology is developed in the 3rd Generation Partnership Project (3GPP) and is meant to deliver higher multi-Gbps peak data speeds, ultra-low latency, more reliability, massive network capacity, increased availability, and a uniform user experience to multiple users. Higher performance and improved efficiency of the 5G technology connects new industries and provides elevated user experiences. Though, with the release of the 5G technology, some of industry required objectives have been met, but there are still a few issues that need to be resolved, such as related to accommodating industry verticals, architectures to support private networks, and supporting flexible network deployments.

In addition, available 5G network architecture supports private networks but only in a rudimentary way. Mechanisms to accommodate dynamic addition/deletion of private/host neutral Radio Access Network (RAN) nodes into a network are not currently available, leading to under-utilization and monetization of any given spectrum pool. Further, the current 5G architecture does not support coreless operation of radio access nodes which may be “host neutral” or from a private deployment or a host of other possible private/public radio access node deployment combinations. Private radio access node deployment needs prior agreements with a macro network operator and prior interoperability with core networks. The available 5G architecture does not support providing a gateway that has the capability to use private RAN node deployments to search for available core networks for certain capabilities, and for the core networks that can search for private RAN deployments for capacity enhancements.

There is, therefore, a need in the art to provide an improved gateway node that acts as a hub in a cellular network architecture and addresses issues of the coreless mode of operation of the radio access nodes and network flexibility.

### OBJECTS OF THE PRESENT DISCLOSURE

It is an object of the present disclosure to provide a network architecture with a gateway acting as a private access connection hub to connect to one or more Core Networks (CN).

It is an object of the present disclosure to allow the gateway to be deployed by a third party that connects Radio Access Network (RAN) nodes to the one or more CNs.

It is an object of the present disclosure to provide a gateway-assisted cellular network architecture, where during a mobility scenario, paging is successful only after a successful update is performed on a User Equipment (UE) at different levels.

It is an object of the present disclosure to allow the gateway to be provided as a service by any entity other than the RAN and the CN service providers.

It is an object of the present disclosure to enhance the communication system.

It is an object of the present disclosure to dynamically manage the network requirements using a gateway-assisted network.

It is an object of the present disclosure to provide network upgrades to support sixth generation (6G) communication technology.

It is an object of the present disclosure to optimize the network infrastructure cost.

It is an object of the present disclosure to enhance the data security.

It is an object of the present disclosure to dynamically allocate the infrastructure based on user defined requirements.

It is an object of the present disclosure to provide on demand telecom infrastructure.

It is an object of the present disclosure to facilitate the paging and tracking area related aspects in a network communication.

### SUMMARY

This section is provided to introduce certain objects and aspects of the present disclosure in a simplified form that are further described below in the detailed description. This summary is not intended to identify the key features or the scope of the claimed subject matter.

In an aspect, the present disclosure relates to a system comprising one or more processors and a memory storing instructions that, when executed by the one or more processors, causes the system to determine a unique UE context of a UE for each of a first coverage state of the UE and a second coverage state of the UE. The one or more processors may dynamically save the determined unique UE context of the UE. Further, the one or more processors may transmit a paging message to a CN. The unique UE context may be saved at the CN to provide a seamless mobility service to the UE.

In an embodiment, the first coverage state may correspond to the UE being within a coverage area provided by the system and the second coverage state may correspond to the UE being outside the coverage area provided by the system.

In an embodiment, the system may act as an independent hub for establishing a connection between a Radio Access Network (RAN) node and the CN.

In an embodiment, the system may specify radio access capabilities of the RAN node to the UE. The radio access capabilities may include information related to at least one of a type, band, spectrum, bandwidth, and offsets associated with the RAN node.

In an embodiment, the system may include at least one of a spectrum negotiation capability, a payment capability, a paging and tracking capability, and a security maintenance capability.

In an embodiment, the system and the CN may send a paging message to a network node and a core network node respectively, when a download (DL) message is to be delivered from the CN to the UE.

In an embodiment, the paging message is sent on completion of a successful handover between the network node and the core network node via the system.

In an aspect, the present disclosure relates to a method for determining a unique UE context of a UE for each of a first coverage state of the UE and a second coverage state of the UE. The system may dynamically save the determined unique UE context of the UE. The system may transmit a paging message to a CN. The unique UE context is saved at the CN to provide a seamless mobility service to the UE.

In an aspect, the present disclosure relates to a non-transitory computer-readable medium comprising processor-executable instructions that causes a processor to determine a unique UE context of a UE for each of a first coverage state of the UE and a second coverage state of the UE. The processor may dynamically save the determined unique UE context of the UE. The processor may transmit a paging message to a CN. The unique UE context is saved at the CN to provide a seamless mobility service to the UE.

In an aspect, the present disclosure relates to a UE, including one or more processors and a memory operatively coupled to the one or more processors and a system, where the system is configured to determine a unique UE context of the UE for each of a first coverage state of the UE and a second coverage state of the UE. The system may dynamically save the determined unique UE context of the UE. The system may transmit a paging message to a CN. The unique UE context is saved at the CN to provide a seamless mobility service to the UE.

### BRIEF DESCRIPTION OF THE DRAWINGS

The accompanying drawings, which are incorporated herein, and constitute a part of this disclosure, illustrate exemplary embodiments of the disclosed methods and systems which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes the disclosure of electrical components, electronic components, or circuitry commonly used to implement such components.

FIG. 1 illustrates an isolated private fifth generation (5G) network architecture.

FIGS. 2A-2B illustrate exemplary shared private 5G network architectures.

FIG. 3A illustrates a connectivity architecture showing a gateway node acting as a core network (CN) interface, in accordance with an embodiment of the present disclosure.

FIG. 3B illustrates an exemplary network architecture showing the gateway node acting as an interface for the CN, in accordance with an embodiment of the present disclosure.

FIG. 3C illustrates an exemplary block diagram of the gateway node, in accordance with an embodiment of the present disclosure.

FIG. 4 illustrates a process flow diagram showing mutual authentication of a 6G Core Network (6GCN) and the gateway, in accordance with an embodiment of the present disclosure.

FIG. 5 illustrates a process flow diagram depicting the gateway querying the CN for its capabilities, in accordance with an embodiment of the present disclosure.

FIG. 6 illustrates an exemplary representation of the gateway acting as a hub, in accordance with an embodiment of the present disclosure.

FIG. 7 illustrates a process flow diagram showing the CN querying the gateway for availability of Radio Access Network (RAN) nodes to provide a service, in accordance with an embodiment of the present disclosure.

FIG. 8 illustrates a process flow diagram depicting the RAN nodes querying the gateway for determining availability of the CN for providing a particular service, in accordance with an embodiment of the present disclosure.

FIG. 9 illustrates a sequence flow diagram representing handling of various issues in a no mobility scenario, in accordance with an embodiment of the present disclosure.

FIG. 10 illustrates a sequence flow diagram representing handling of the various issues in a low mobility scenario, in accordance with an embodiment of the present disclosure.

FIGS. 11A-11C illustrate a sequence flow diagram representing handling of the various issues in a wide area mobility scenario, in accordance with an embodiment of the present disclosure.

FIG. 12 illustrates a sequence flow illustrating operations performed by the gateway node acting as a hub in the cellular network architecture, in accordance with an embodiment of the present disclosure.

FIG. 13 illustrates an exemplary computer system in which or with which embodiments of the present disclosure may be implemented.

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail to avoid obscuring the embodiments.

Also, it is noted that individual embodiments may be described as a process that is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive in a manner similar to the term “comprising” as an open transition word without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the disclosure. As used herein, the singular forms “a”, “an”, and “the” are intended to include the plural forms as well, unless the context indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

A private Fifth Generation (5G) network architecture may be categorized into multiple categories which are described below, according to different deployment options with a level of integration with a mobile operator's public network.
Isolated network: Here, an entire private network is owned and operated by a user and completely isolated from a public network.
Shared network: The shared network has a hybrid configuration that leverages a part of telecom service provider's infrastructure.
Private network slice under public network: Here, the private network is realized by network slicing and leverages an operator's existing public network infrastructure, and offers private connection through software defined network slice.

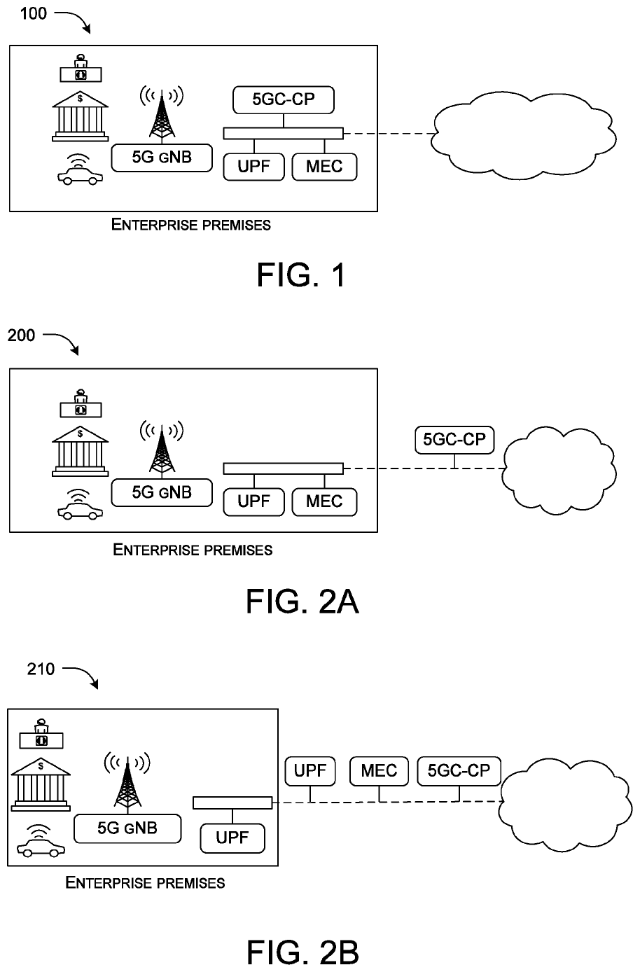

FIG. 1 illustrates an isolated private 5G network architecture 100. In this architecture, the entire network is hosted and operated by the user to ensure full control of the network. The network is completely isolated from the public network, which minimizes risk of data breach. However, investment of building and operating infrastructure of this architecture is very high and requires personnel with a high level of knowledge about telecom networks. The isolated private 5G network architecture is suitable for public safety agencies or large enterprises with an abundance of resources and high concern for data privacy. For example, public communication systems may be maintained for rescue teams with an isolated private 5G network set up in a mobile vehicle.

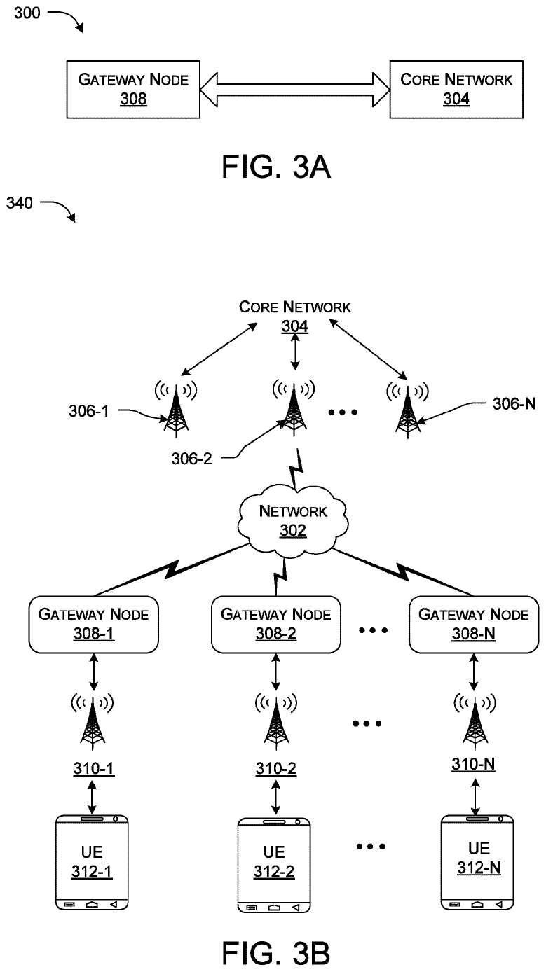

FIGS. 2A-2B illustrate exemplary shared private 5G network architecture 200 and 210, respectively. As is illustrated, the shared private 5G network architecture shares infrastructure of a mobile operator's public network. This is done to reduce the cost of setup for the private 5G network. Depending on business requirement(s), the user may choose how many components will be managed by themselves versus by the mobile operator. By way of an example, in case of a smart factory, it may be better to leave Multi-Access Edge Computing (MEC) and User Plane Function (UPF) on premises. This may allow for providing a private 5G architecture where the user may get low latency communication with a room for future modifications. For other types of use case scenarios such as stadiums or exhibition centres, where a fast and stable connection is needed, the business owner may maintain a Radio Access Network (RAN) locally. This may help to ensure that network coverage and network quality is under control while leaving system management to the mobile operator.

The present disclosure relates to an architecture that supports dynamic association/disassociation between a private RAN (interchangeably also referred to as a host neutral RAN node/mobility node/RAN node, herewith) and a core network via a gateway (interchangeably also referred to as a gateway node, a gateway hub, herewith). The gateway provides necessary security considerations, spectrum negotiation capabilities, payment capabilities, and facilitates to execute associated procedures and mechanisms. The gateway based association between the RAN and the core network also serves mobile radio scenarios, where the RAN node may be an Unmanned Aerial Vehicle (UAV) and may not have access to the core network for certain periods of time.

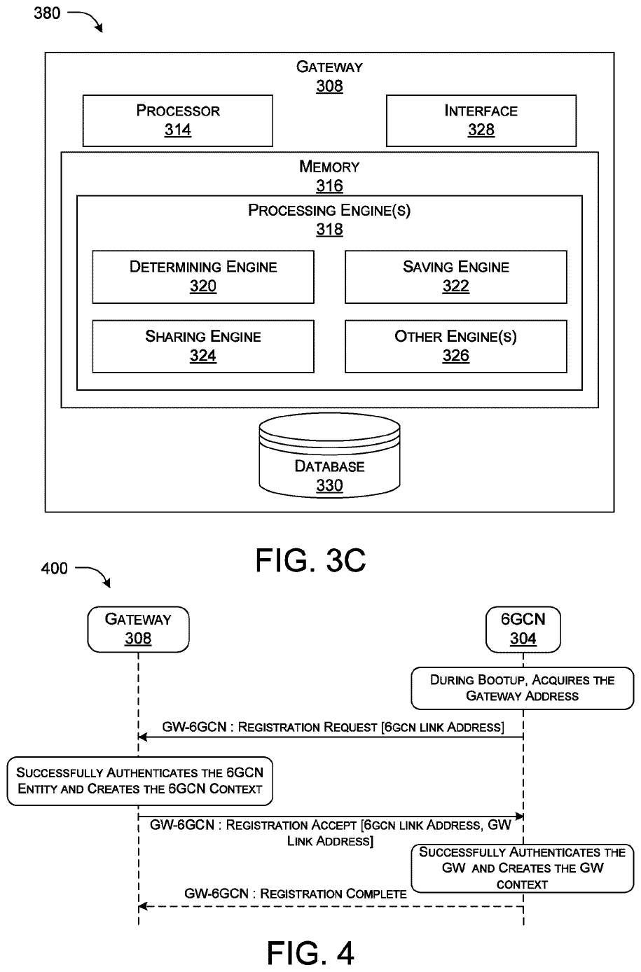

Various embodiments of the present disclosure will be explained in detail with reference to FIGS. 3-13.

FIG. 3A illustrates a connectivity architecture 300 showing the gateway node 308 acting as a core network interface, in accordance with an embodiment of the present disclosure. As is illustrated in FIG. 3, there exists the gateway node 308, that acts as an interface for the core network (CN) 304 (also referred to herein as a 6G Core Network (6GCN) 304) in a connectivity network architecture. The gateway node 308 may be owned by the mobile operator. The gateway node 308 may be implemented as a system and may be interchangeably referred to as a system 308.

FIG. 3B illustrates an exemplary network architecture 340 showing the gateway node 308 acting as the interface for the CN 304, in accordance with an embodiment of the present disclosure.

As illustrated in FIG. 3B, by way of example and not by not limitation, the exemplary network architecture 340 may include a plurality of User Equipments (UEs) 312-1, 312-2 . . . 312-N, which may be individually referred as the UE 312 and collectively referred as the UEs 312. It may be appreciated that the UE 312 may be interchangeably referred to as a user device, a client device, or a computing device. The plurality of UEs 312 may include, but not be limited to, scanners such as cameras, webcams, scanning units, and the like.

In an embodiment, the UE 312 may include smart devices operating in a smart environment, for example, an Internet of Things (IoT) system. In such an embodiment, the UE 312 may include, but is not limited to, smart phones, smart watches, smart sensors (e.g., mechanical, thermal, electrical, magnetic, etc.), networked appliances, networked peripheral devices, networked lighting system, communication devices, networked vehicle accessories, networked vehicular devices, smart accessories, tablets, smart television (TV), computers, smart security system, smart home system, other devices for monitoring or interacting with or for the users and/or entities, or any combination thereof.

A person of ordinary skill in the art will appreciate that the computing device, or the user device, or the UE 312 may include, but is not limited to, intelligent, multi-sensing, network-connected devices, that can integrate seamlessly with each other and/or with a central server or a cloud-computing system or any other device that is network-connected.

In an embodiment, the UE 312 may include, but is not limited to, a handheld wireless communication device (e.g., a mobile phone, a smartphone, a phablet device, and so on), a wearable computer device (e.g., a head-mounted display computer device, a head-mounted camera device, a wristwatch computer device, and so on), a Global Positioning System (GPS) device, a laptop computer, a tablet computer, or another type of portable computer, a media playing device, a portable gaming system, and/or any other type of computer device with wireless communication capabilities, and the like. In an embodiment, the UE 312 may include, but is not limited to, any electrical, electronic, electromechanical, or an equipment, or a combination of one or more of the above devices such as virtual reality (VR) devices, augmented reality (AR) devices, a laptop, a general-purpose computer, a desktop, a personal digital assistant, a tablet computer, a mainframe computer, or any other computing device, wherein the UE 312 may include one or more in-built or externally coupled accessories including, but not limited to, a visual aid device such as a camera, an audio aid, a microphone, a keyboard, and input devices for receiving input from the user or the entity such as a touch pad, a touch enabled screen, an electronic pen, and the like.

A person of ordinary skill in the art will appreciate that the UE 312 may not be restricted to the mentioned devices and various other devices may be used.

In an exemplary embodiment, the UE 312 may communicate with the CN 304 through the gateway node 308 via a network 302. The gateway nodes 308-1, 308-2, . . . 308-N, may be individually referred as the gateway node 308 and collectively referred as the gateway nodes 308. The gateway nodes 308 may be one or more gateways such as, for example, one or more Next-Generation Radio Access Network (NG-RAN) node gateways or one or more home NG-RAN node gateways. The network 302 may include, by way of example but not limitation, at least a portion of one or more networks having one or more nodes that transmit, receive, forward, generate, buffer, store, route, switch, process, or a combination thereof, etc. one or more messages, packets, signals, waves, voltage or current levels, some combination thereof, or so forth. The network 302 may include, by way of example but not limitation, one or more of: a wireless network, a wired network, an internet, an intranet, a public network, a private network, a packet-switched network, a circuit-switched network, an ad hoc network, an infrastructure network, a public-switched telephone network (PSTN), a cable network, a cellular network, a satellite network, a fiber optic network, some combination thereof.

In an exemplary embodiment, the CN 304 may be associated with a plurality of base stations 306-1, 306-2, . . . 306-N, which may be individually referred as the base station 306 and collectively referred as the base stations 306. The base station 306 may include, but not limited to, a macro base station, a small cell base station, and the like. It may be appreciated that the base station 306 may be a Next-Generation Node B (gNB). The base station 306 may also be referred to as a core network node 306 or a gNodeB 306, hereinafter.

In an exemplary embodiment, to provide communication between the UE 312 and the CN 304, one or more network nodes 310-1, 310-2, . . . 310-N, which may be individually referred as the network node 310 and collectively referred as the network nodes 310, may be dispersed over a geographic area. The network nodes 310 may use radio communication technology to communicate with the UEs 312 via communication channels. For example, a respective network node 310 may be configured as a base station. In various embodiments, the communication channels may be associated with a licensed spectrum. Further, the network node 310 may also interface the UEs 312 with the CN 304. As is shown in FIG. 3B, the network node 310-1 may act as an interface for the UE 312-1 with the CN 304 via the gateway node 308-2. Further, the network node 310-N may act as an interface for the UE 312-N with the CN 304 via the gateway node 308-N. The network node 310 may also be referred to as a RAN node 310, herewith.

In an embodiment, a paging message is transferred from the core network node 306, via the gateway node 308, to the UE 312 connected to the network node 310. The core network node 306 may be connected to the CN 304. In an embodiment, the paging message may be transferred on successful completion of a handover between the UE 312 and the CN 304. In an embodiment, the UE 312 may receive the paging message and a Download (DL) message from the core network node 306, via the gateway node 308. The UE 312 may connect to the paging message and perform continuous measurements with respect to the core network node 306. As may be appreciated, the continuous measurements may correspond to the core network node 306 having predetermined strength to provide a seamless mobility service to the UE 312.

In an embodiment, the gateway node 308 may determine a unique UE context of the UE 312 for each of a first coverage state and a second coverage state of the UE 312. Further, based on the determined unique UE context of the UE 312, the gateway node 308 may dynamically save the UE context. In addition, gateway node 308 may share the paging message with the CN 304. The unique UE context may be saved at the CN 304 to provide a seamless mobility service to the UE 312. In an embodiment, the first coverage state may correspond to the UE 312 being within a coverage area provided by the gateway node 308 and the second coverage state corresponds to the UE 312 being outside the coverage area provided by the gateway node 308. In an embodiment, the gateway node 308 may act as an independent hub for establishing a connection between a Radio Access Network (RAN) node and the CN.

In an embodiment, when the DL message is to be delivered from the CN 304 to the UE 312, the gateway node 308 and the CN 304 may send a paging message to the network node 310 and the core network node 306 respectively. The paging message may be sent on completion of a successful handover, via the gateway node 308, between the network node 310 and the core network node 306.

Although FIG. 3B shows exemplary components of the network architecture 340, in other embodiments, the network architecture 340 may include fewer components, different components, differently arranged components, or additional functional components than depicted in FIG. 3B. Additionally, or alternatively, one or more components of the network architecture 340 may perform functions described as being performed by one or more other components of the network architecture 340.

In an embodiment, the gateway node 308 may facilitate the private RAN node 310 deployments to search for available CN 304 for certain capabilities. In addition, the CN 304 may search for private RAN deployments for capacity enhancement. The gateway node 308 may, in such a scenario, act as the hub. In another deployment, the gateway node 308 may be a part of the core/macro network deployment.

In an embodiment, the gateway node 308 may act as an independent hub for the one-to-many RAN node 310 to core network connectivity. The gateway node 308 may provide the necessary security considerations, the spectrum negotiation capabilities, the payment capabilities, manage the associated procedures and mechanisms, and maintain paging and tracking area considerations.

FIG. 3C illustrates an exemplary block diagram 380 of the gateway node 308, in accordance with an embodiment of the present disclosure.

In an embodiment, and as shown in FIG. 3C, the gateway node 308 may include one or more processors 314. The one or more processors 314 may be implemented as one or more microprocessors, microcomputers, microcontrollers, digital signal processors, central processing units, logic circuitries, and/or any devices that manipulate data based on operational instructions. Among other capabilities, the one or more processors 314 may be configured to fetch and execute computer-readable instructions stored in a memory 316 of the gateway node 308. The memory 316 may store one or more computer-readable instructions or routines, which may be fetched and executed to create or share the data units over a network service. The memory 316 may comprise any non-transitory storage device including, for example, volatile memory such as Random-Access Memory (RAM), or non-volatile memory such as an Erasable Programmable Read-Only Memory (EPROM), a flash memory, and the like.

In an embodiment, the gateway node 308 may also include an interface(s) 328. The interface(s) 328 may include a variety of interfaces, for example, a variety of interfaces, for example, interfaces for data input and output devices, referred to as I/O devices, storage devices, and the like. The interface(s) 328 may facilitate communication of the gateway node 308 with various devices coupled to it. The interface(s) 328 may also provide a communication pathway for one or more components of the gateway node 308. Examples of such components include, but are not limited to, processing engine(s) 318 and a database 330.

In an embodiment, the processing engine(s) 318 may be implemented as a combination of hardware and programming (for example, programmable instructions) to implement one or more functionalities of the processing engine(s) 318. In examples, described herein, such combinations of hardware and programming may be implemented in several different ways. For example, the programming for the processing engine(s) 318 may be processor-executable instructions stored on a non-transitory machine-readable storage medium and the hardware for the one or more processors 314 may comprise a processing resource (for example, one or more processors), to execute such instructions. In the present examples, the machine-readable storage medium may store instructions that, when executed by the processing resource, implement the processing engine(s) 318. In such examples, the gateway node 308 may comprise the machine-readable storage medium storing the instructions and the processing resource to execute the instructions, or the machine-readable storage medium may be separate but accessible to the gateway node 308 and the processing resource. In other examples, the processing engine(s) 318 may be implemented by an electronic circuitry.

In an embodiment, the database 330 may comprise data that may be either stored or generated as a result of functionalities implemented by any of the components of the processors 314 or the processing engine(s) 318 or the gateway node 308.

In an exemplary embodiment, the processing engine(s) 318 may include one or more engines selected from any of a determining engine 320, a saving engine 322, a sharing engine 324, and other units/engines 326. The other units/engines 326 may include, but are not limited to, a monitoring engine, a receiving engine, and the like.

In an embodiment, the one or more processors 314 may, via the determining engine 320, determine a unique UE context of the UE 312 for each of a first coverage state of the UE 312 and a second coverage state of the UE 312. The first coverage state may correspond to the UE 312 being within a coverage area provided by the gateway node 308 and the second coverage state may correspond to the UE 312 being outside the coverage area provided by the gateway node 308. The unique UE context may be saved at the gateway node 308. The gateway node 308 may act as an independent hub for establishing a connection between the RAN node 310 and the CN 304.

In an embodiment, the one or more processors 314 may, via the saving engine 322, dynamically save the determined unique UE context of the UE 312.

In an embodiment, the one or more processors 314 may, via the sharing engine 324, share a paging message with the CN 304. The unique UE context is saved at the CN to provide a seamless mobility service to the UE 312. The gateway node may specify radio access capabilities of the RAN node 310 to the UE 312. The radio access capabilities include, for example, information related to at least one of a type, band, spectrum, bandwidth, and offsets associated with the RAN node 310. The gateway node 308 may include at least one of a spectrum negotiation capability, a payment capability, a paging and tracking capability, and a security maintenance capability.

In an embodiment, when the DL message is to be delivered from the CN 304 to the UE 312, the gateway node 308 and the CN 304 may send a paging message to the network node 310 and the core network node 306 respectively. The paging message may be sent on completion of a successful handover, via the gateway node 308, between the network node 310 and the core network node 306.

Although FIG. 3C shows exemplary components of the gateway node 308, in other embodiments, the gateway node 308 may include fewer components, different components, differently arranged components, or additional functional components than depicted in FIG. 3C. Additionally, or alternatively, one or more components of the gateway node 308 may perform functions described as being performed by one or more other components of the gateway node 308.

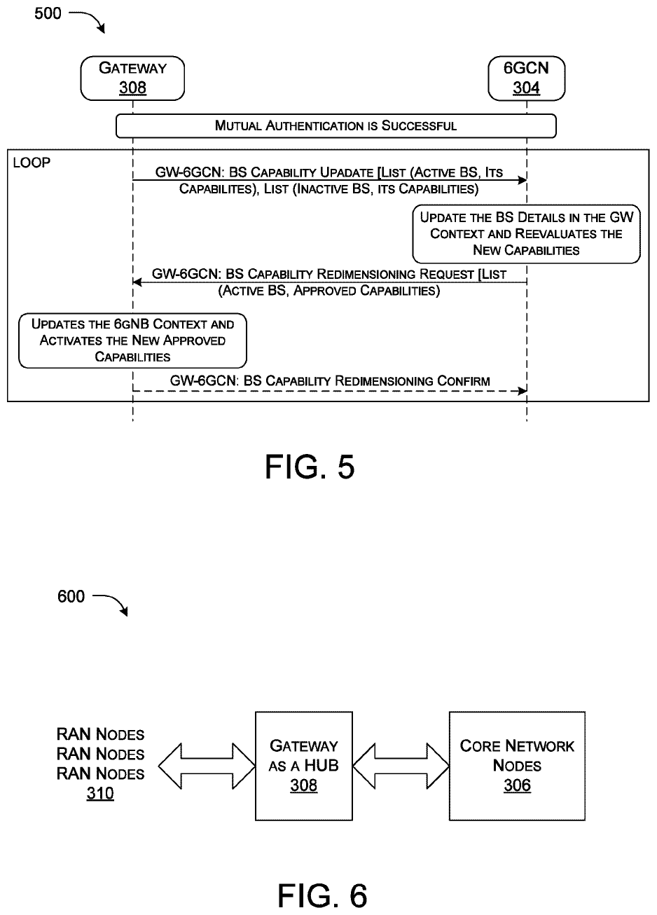

FIG. 4 illustrates a process flow diagram 400 showing mutual authentication of the 6GCN 304 and the gateway 308, in accordance with an embodiment of the present disclosure.

With respect to FIG. 4, the 6GCN 304 and the gateway 308 may mutually authenticate each other, and create a local context of each other (i.e. the 6GCN 304 may have a gateway context and vice versa). The context may be, for example, a list of private network groups (IDs), private base stations (IDs), negotiated Quality of Service (QoS)/Quality of Experience (QoE) for the base stations/groups of the base stations, and/or the bandwidth collective or individually assured for the base station or the users/devices/device types behind the base station.

The gateway 308 may query the CN/6GCN 304 for its capabilities and may cache capabilities of the CN 304. The capabilities of the CN 304 may be, for example, spectrum information, information related to the RAN load headroom that the CN 304 may use in a given location and an ability to provide a certain class of the QoS/QoE experience for a certain class of available devices/applications.

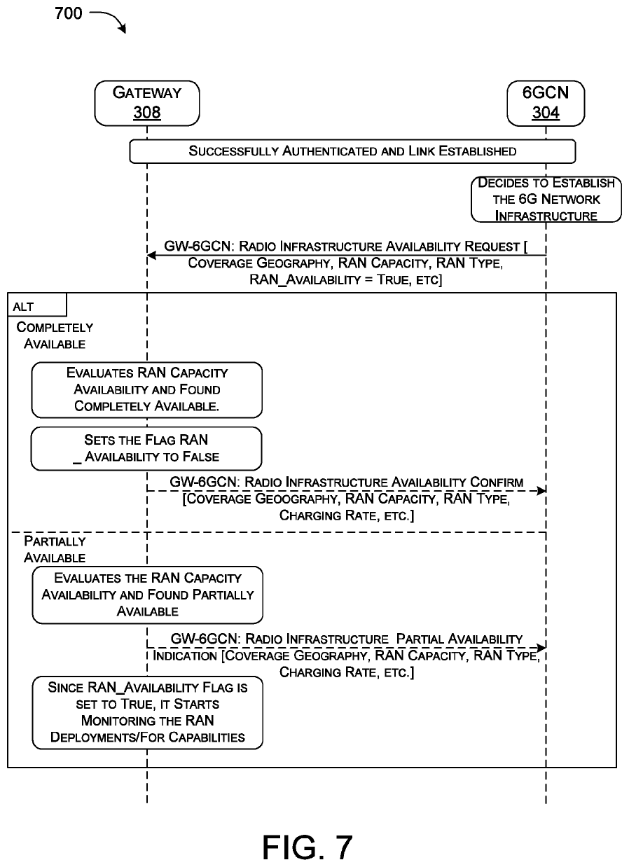

FIG. 5 illustrates a process flow diagram 500 depicting the gateway 308 querying the CN 304 for its capabilities, in accordance with an embodiment of the present disclosure. In an embodiment, the gateway 308 may also act as a hub i.e. the gateway 308 may be deployed by a “gateway service provider” and the hub may advertise the services. Multiple radio base stations may use a hub gateway to connect to different CNs 304 for availing varied services. The services of the CN 304 may include, for example, serving a certain class of applications such as Internet of Things (IoT), providing video surveillance connectivity with video analytics, conversational class of services, gaming service, and the like.

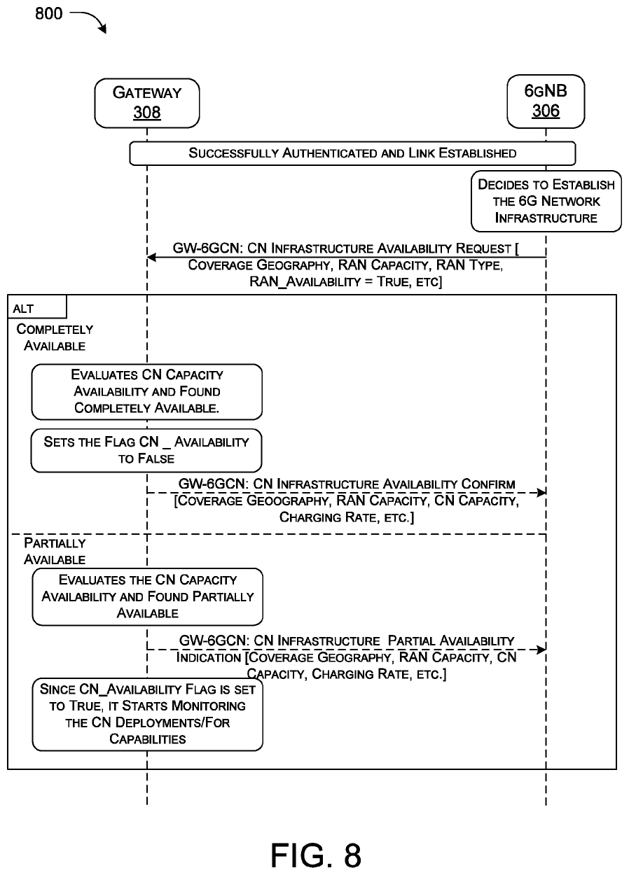

FIG. 6 illustrates an exemplary representation 600 of the gateway 308 acting as the hub, in accordance with an embodiment of the present disclosure. As is illustrated, the gateway 308 as the hub scenario follows a similar flow as discussed in earlier paragraphs, except that the hub may have a prior context information of the RAN nodes 310, and what they are looking for, or context information of the CNs 304 and what they are looking for. In an embodiment, a prior registration and querying of the gateway hub 308 by either the RAN node 310 or the CN 304 is possible. The CN 304 or the RAN node 310 may register with the gateway 308 through a call back when the CN 304/the RAN node 310 becomes available.

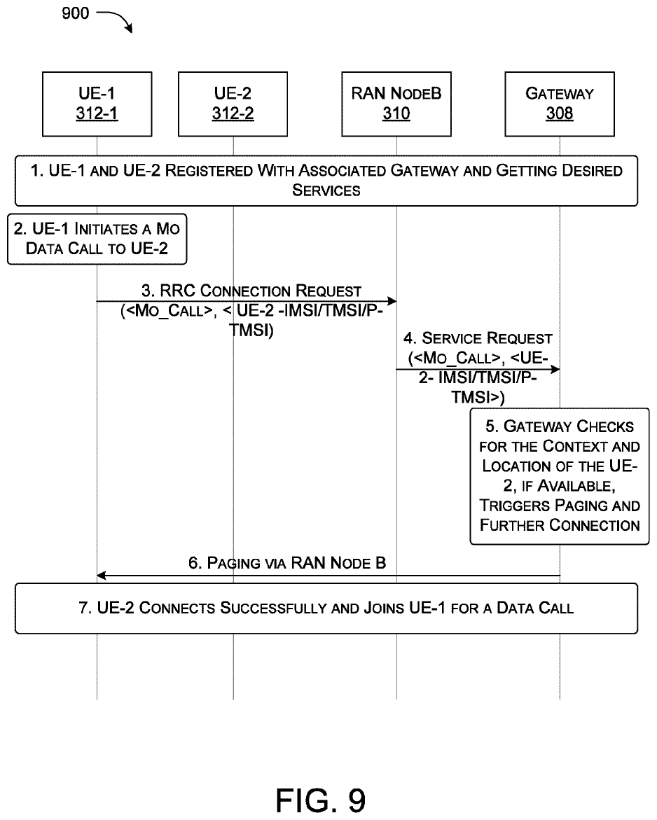

FIG. 7 illustrates a process flow diagram 700 showing the CN 304 querying the gateway 308 for availability of the RAN nodes 310 to provide a service, in accordance with an embodiment of the present disclosure.

As illustrated, the CN 304 may query the gateway 308 for availability of the RAN nodes 310 with a headroom for providing the service. However, if the service/headroom is not available, then the CN 304 may register with the gateway 308 for a call-back when such RAN nodes 310 register with the gateway 308. As may be appreciated, parameter “coverage geography” provides Global Positioning System (GPS) coordinates about a geographic area, over which the RAN capability may be provided or made available. Parameter “RAN capacity” provides capacity details such as number of 6gNodeBs (6gNBs) needed, support of number of connected users needed, total throughput support needed, latency support needed, QoS support needed, and the like. Parameter “RAN type” indicates whether the RAN capability is needed based on macro type 6gNBs only or small cell based 6gNBs only or combination of either types, or Non-Terrestrial Networks (NTN) based 6gNBs only, or combinations of all, etc. Parameter “RAN availability” is a flag, which when set to “true,” indicates to the gateway that it may start monitoring the requested RAN capacity availability, and once it meets the expectation, then the confirmation may be sent to the requested 6GCN. Parameter “charging rate” provides details about charging rate aspects, and applicability of the rate with respect to time duration or time frame.

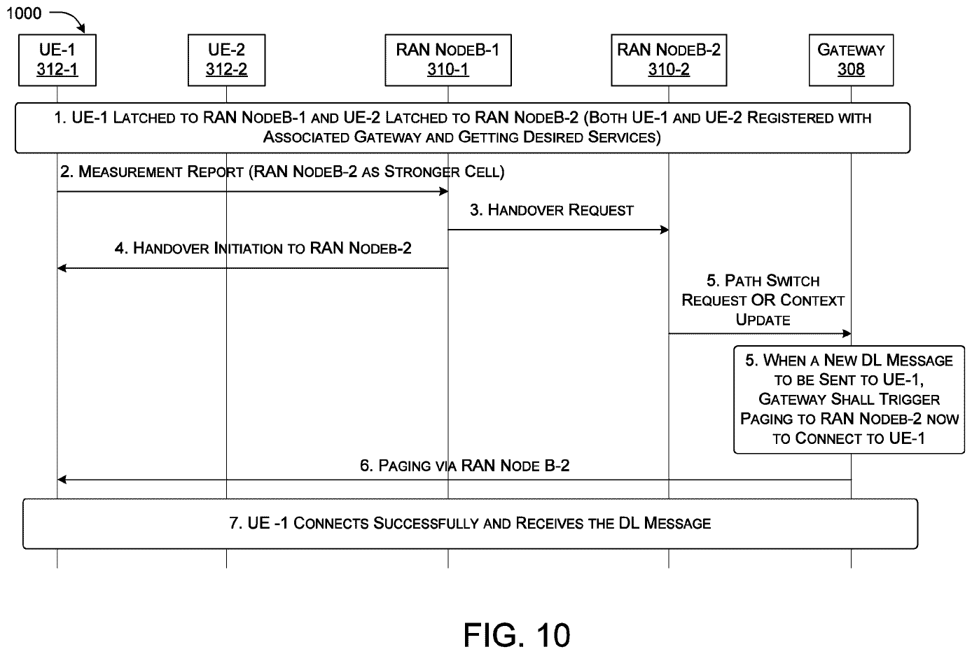

FIG. 8 illustrates a process flow diagram 800 depicting the RAN nodes 310 querying the gateway 308 for determining availability of the CN 304 for providing a particular service, in accordance with an embodiment of the present disclosure.

As illustrated, the RAN nodes 310 may query the gateway 308 for availability of the CN 304 that may provide a certain service for QoS/QoE Key Performance Indicators (KPIs), or for availability of certain bandwidth/load handling capabilities. If such a service/headroom is not available at the CN 304, then the RAN nodes 310 may register with the gateway 308 for a call-back when such service headroom becomes available at the CN 304. The parameter “coverage geography” may provide the GPS coordinates about a geographic area, over which the core network capability needs to be provided or made available. The parameter “RAN capacity” may provide the required capacity details, for example, need of a number of 6gNBs, requirement of support for a number of connected users, support for total throughput, latency, and QoS, and the like. The parameter “CN capacity” may provide the CN capacity details like the latency, number of users supported, QoS supported, slicing support, load balancing support, Access Traffic Steering, Switching and Splitting (ATSSS) support, etc. The parameter “CN Availability” is a flag, which when set to ‘true,’ indicates to the gateway that it may start monitoring the requested CN capacity availability. Upon meeting the expectation, a confirmation may be sent to the requested 6GNB(s) 306. The parameter “charging rate” may provide details about the charging rate aspects, and applicability of the rate with respect to the time duration or time frame.

In an embodiment, the gateway 308 may be responsible to maintain the UE context for a given “private RAN node(s).” In another embodiment, various device types may be classified at the RAN node 310 based on mobility type of the UE 312 (i.e., mobility available within a campus/enterprise, wide area mobility, or no mobility). Appropriate handling of the mobility context to tackle mobility issues of the UE 312 is explained in detail in subsequent paragraphs.

In terms of the mobility context, three scenarios may be considered at a broad level: a no mobility scenario, a low mobility scenario, and a wide area mobility scenario for handling various issues like paging context/location area tracking/providing an update at the gateway 308.

For a no mobility scenario, the gateway 308 and a localized private RAN node 310 may be a part of a campus/enterprise which provides data services, and it is assumed to have only such a RAN node 310. Thus, the RAN node 310 may need to support very restricted mobility for its users/UEs 312.

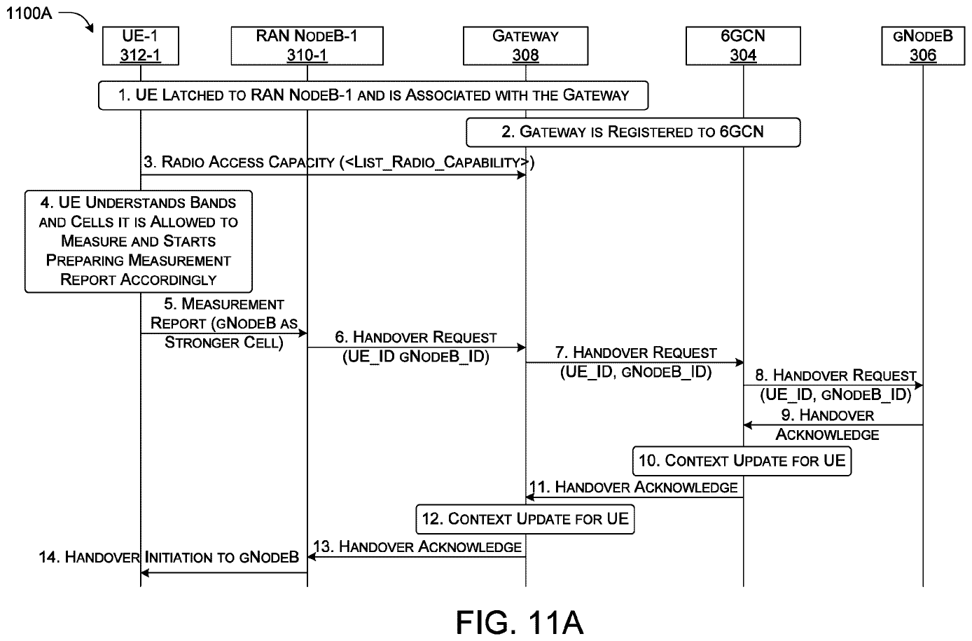

FIG. 9 illustrates a sequence flow diagram 900 representing handling of various issues in the no mobility scenario, in accordance with an embodiment of the present disclosure.

For this scenario, the following steps are followed:
At step 1, the UE 1 312-1 and the UE 2 312-2 are registered for desired services with the gateway 308 that is associated with a local or a private RAN NodeB 310.
At step 2, the UE 1 312-1 initiates a Mobile Originating (MO) data call towards the UE 2 312-2.
At step 3, the UE 1 312-1 sends a Radio Resource Control (RRC) connection request with cause as the MO call to local or private RAN NodeB 310.
At step 4, the RAN NodeB 310 passes a message to the gateway 308 via a service request along with the UE identity and an establishment cause.
At step 5, the gateway 308 checks for availability of context and location information about the UE 1312-1.
At step 6, if the context and the information is found, then the gateway 308 does paging to the RAN NodeB 310 which in turn passes a message over a Paging Channel (PCH) in search of the UE 2 312-2.
At step 7, the UE 2 312-2 connects and joins a data call with the UE 1 312-1.

For a low mobility scenario, it is considered that the gateway 308 and localized private RAN nodes 310 are a part of a campus/enterprise which provides data services and are assumed to have more than one such RAN node 310, and the UE 312 is allowed to freely roam around between these RAN nodes 310 served by the gateway 308. Thus, here the gateway 308 may need to maintain a UE context related to, into which private RAN node 310 a given UE 312 is attached to and is being served. Based on this information, the paging may be taken care of for any incoming messages/calls.

As may be appreciated, a set of pre-conditions are declared for the low mobility scenario. A particular gateway 308 may be assumed to have a minimum of two RAN NodeBs 310 associated with it and should be serving several UEs 312 in its vicinity. So, all the UEs 312 associated or registered to the particular gateway 308 (under a private network) are free to roam around within the radio coverage as provided by the RAN NodeBs 310 associated with the particular gateway 308.

A set of assumptions are followed for the low mobility scenario. An ‘Xn’ interface exists between the two RAN NodeBs 310 to exchange the handover and other similar messages. In case of absence of such an interface, the messages are forwarded via the gateway 308.

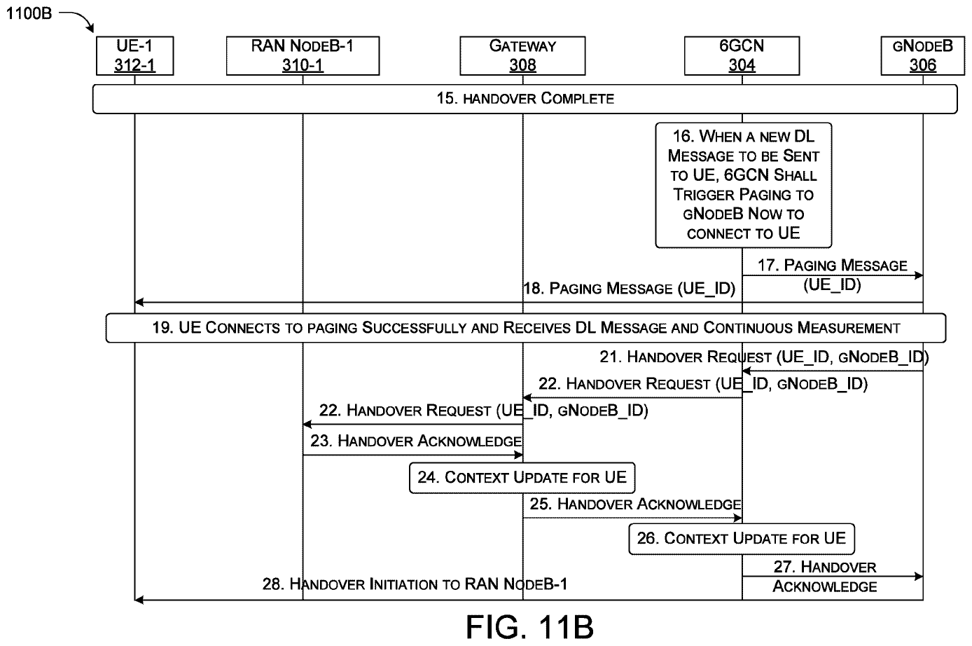

FIG. 10 illustrates a sequence flow diagram 1000 representing handling of the various issues in the low mobility scenario, in accordance with an embodiment of the present disclosure.

Following are the steps followed for exchanging messages in the low mobility scenario:
At step 1, the UE 1 312-1 and the UE 2 312-2 are registered for desired services with the gateway 308 that is associated with the local or private RAN NodeB 310. Here, initially the UE 1 312-1 is latched to RAN NodeB 1 310-1 and the UE 2 312-2 is latched to RAN NodeB 2 310-2.
At step 2, the UE 1 312-1 shares a measurement report with the RAN NodeB 1 310-1, indicating that the RAN NodeB 2 310-2 is a stronger cell than a serving cell.
At step 3, the RAN NodeB 1 310-1 indicates a handover request to the RAN NodeB 2 310-2 and the RAN NodeB 2 310-2 acknowledges the same.
At step 4, the RAN NodeB 1 310-1 sends a handover initiation to the UE 1 312-1 to latch onto RAN NodeB 2 310-2.
At step 5, the RAN NodeB 2 310-2 updates the context of the UE 1 312-1 to the gateway 308 along with location information.
At step 6, the gateway 308 uses this context awareness to page the UE 1 312-1 via the RAN NodeB 2 310-2 to send any Downlink (DL) message.
At step 7, the UE 2 312-2 reads the paging message successfully and connects and receives the DL data message.

For a wide area mobility scenario, the gateway 308 when attached to a given core network may help serve the UE 312 to roam around between a private localized network (as served by the RAN nodes 310 and an associated gateway 308) and a public network. Thus, the gateway 308 may need to maintain a context of the UE 312 when it is within its coverage area v/s when it is outside the coverage area of the gateway 308 and accordingly, manage the paging message along with the CN 304. For such a purpose, the gateway 308 may need to be in absolute synchronization with the CN 304 to make sure the context is rightly saved, and the UEs 312 are served for a seamless mobility related service. The disclosure facilitates determining how this context is saved and kept in synchronization with the CN 312.

As a pre-condition for this scenario, the gateway 308 may be assumed to have one or more registered/associated RAN NodeBs 310. To start with, the UE 312 is attached to the RAN NodeB 1310-1.

In addition, for this scenario, it is assumed that no Xn interface exists between the RAN NodeB 310 and the gNodeB 306. If such an interface exists, then both the RAN NodeB 310 and the gNodeB 306 may talk to each other directly, and the target NodeB may do context update for both the gateway 308 and the 6GCN 304 once the handover is acknowledged from the target NodeB. It is to be noted that the gNodeB 306 indicates a base station of the public network which may be 4G, 5G or 6G.

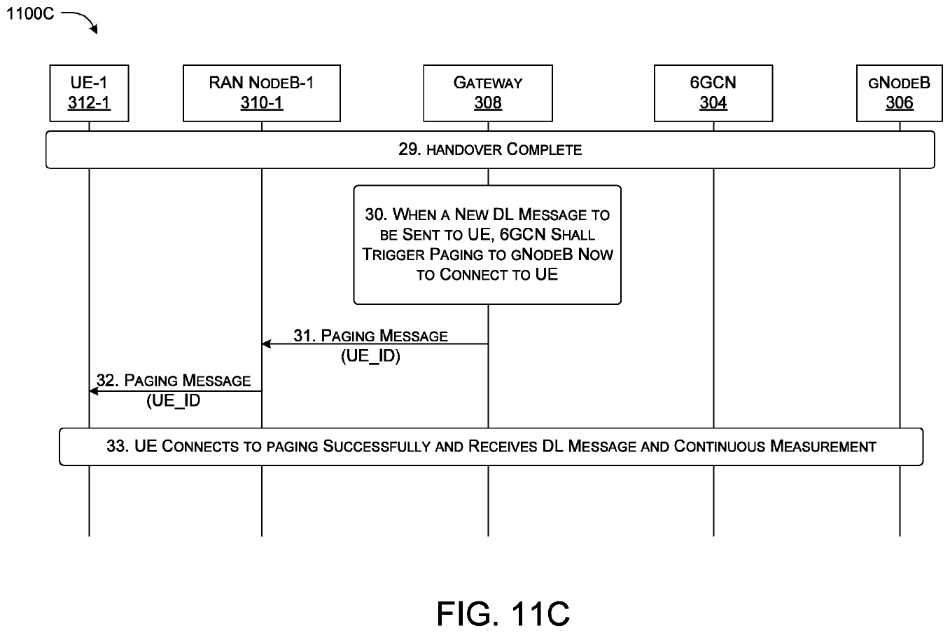

FIGS. 11A-C illustrates a sequence flow diagram 1100A, 1100B, and 1100C representing handling of the various issues in the wide area mobility scenario, in accordance with an embodiment of the present disclosure.

Following sequence flow is followed in the wide area mobility scenario: First, the UE 312 is latched to the RAN NodeB 1 310-1 which is associated with the gateway 308. Then, the gateway 308 is registered to the 6GCN. Next, the radio access capabilities are indicated from the gateway 308 to the UE 312. This capability includes if the gateway 308 is registered to the 6GCN 304 or to any other CN 304, and associated RAN type, band, spectrum, bandwidth, offsets, etc. Thereafter, the UE 312 generates a Measurement Report (MR) indicating the gNodeB 306. Subsequently, a handover request is sent from the RAN NodeB 1 310-1 to the gateway 308 to the 6GCN 304 to the gNodeB 306. Then, the gNodeB 306 acknowledges the handover request and context of the UE 312 is saved at each step, like the gNodeB 306 and the 6GCN 304 respectively. On receiving an acknowledgement, the RAN NodeB 1 310-1 initiates the handover, and the UE 312 moves to the gNodeB 306, and continues measurements. The UE 312 then again sends the MR indicating the RAN NodeB 310 as a stronger cell. Next, the handover request is sent from the gNodeB 306 to the 6GCN 304 to the gateway 308 to the RAN NodeB 310. Thereafter, the handover is acknowledged by the RAN NodeB 1 310-1 which is passed to the gNodeB 306 via the gateway 308 to the 6GCN 304. Next, the gNodeB 306 initiates the handover to the UE 312 to move to the RAN NodeB 1 310-1. Since context is saved at the gateway 308 and the 6GCN 304 (as discussed in preceding sequence flow) during the above-mentioned steps, next time when the DL message needs to be sent to the UE 312, then both the 6GCN 304 and the gateway 308 may have ways to send paging to a right base station (i.e., the RAN NodeB 310 and the gNodeB 306) and then to the UE 312 successfully. Finally, it is maintained that a UE_ID in this case is always needed to associate to a gateway ID (GW_ID) so that the 6GCN knows which gateway it needs to contact to connect to a given UE.

In an embodiment, there is provided a schema of the UE_ID. The UE_ID, in such a case, needs to be associated with a GW_ID, especially when messages are exchanged between the gateway 308 and the 6GCN 304 and vice versa. Thus, such UE_IDs may be defined as:

$$UE\_ID = < GW\_ID > + < International Mobile Subscriber Identity ( IMSI ) / Temporary Mobile Subscriber Identity ( TMSI ) / Packet Temporary Mobile Subscriber Identity ( P - TMSI ) >$$

The gateway 308 when communicating to the 6GCN 304 appends the GW_ID and sends it to the 6GCN 304. This is then used (after decoding) by the 6GCN 304 to communicate the gateway 308 associated with the GW_ID. Later, the gateway 308 removes this GW_ID and uses the remaining of UE_ID to communicate to a respective UE 312.

### Scheme of Radio Access Capability:

Radio_Access_Capability::{RAT_Type=={4G, 5G, 6G,,,},
{Bands_Supported}.
{Bandwidth}.
{Handover_Offset}, . . . }

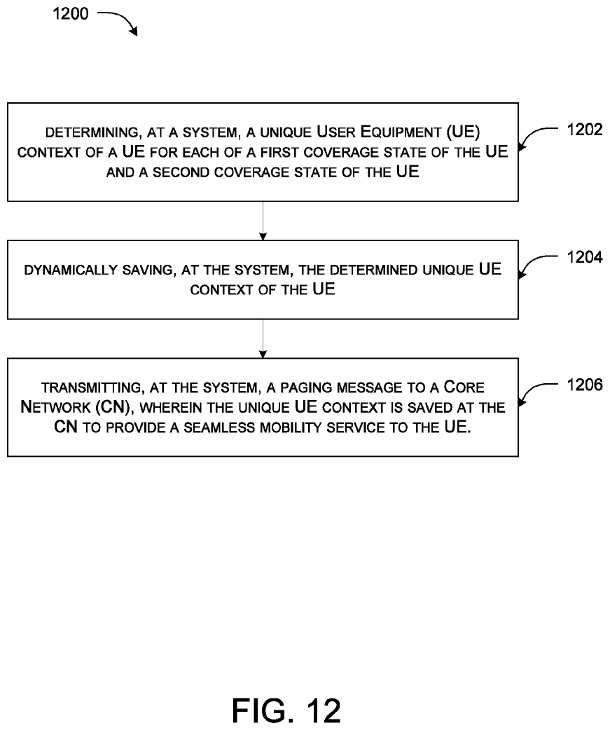

FIG. 12 illustrates a sequence flow of a method 1200 illustrating operations performed by the system 308 acting as a hub in the cellular network architecture, in accordance with an embodiment of the present disclosure. With respect to FIG. 12, the system 308 may, at 1202, determine the unique UE context of the UE 312 for each of a first coverage state of the UE and a second coverage state of the UE. The system 308, at 1204, may dynamically save the determined unique UE context of the UE 308. The system 308 may then transmit a paging message to the CN 304. The unique UE context may be saved at the CN 304, at 1206, to provide a seamless mobility service to the UE 308.

With respect to the proposed cellular network architecture, for paging related information, when the gateway is present in the middle of the RAN and the CN, then during every movement between multiple cells, the context and location information of the UE is known at both the 6GCN and the gateway. Therefore, during such a mobility scenario, the paging is successful only after a successful update is performed at different levels on the UE context of the given UE.

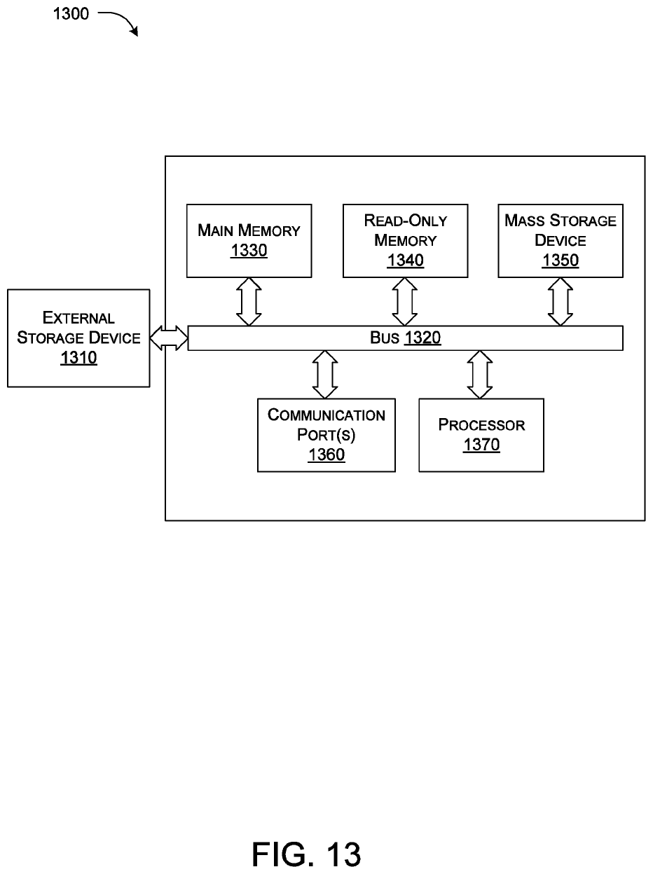

FIG. 13 illustrates an exemplary computer system 1300 in which or with which embodiments of the present disclosure may be implemented.

As shown in FIG. 13, the computer system 1300 may include an external storage device 1310, a bus 1320, a main memory 1330, a read-only memory 1340, a mass storage device 1350, communication port(s) 1360, and a processor 1370. A person skilled in the art will appreciate that the computer system 1300 may include more than one processor and communication ports. The processor 1370 may include various modules associated with embodiments of the present disclosure. The communication port(s) 1360 may be any of an RS-232 port for use with a modem based dialup connection, a 10/100 Ethernet port, a Gigabit or 10 Gigabit port using copper or fiber, a serial port, a parallel port, or other existing or future ports. The communication port(s) 1360 may be chosen depending on a network, such a Local Area Network (LAN), Wide Area Network (WAN), or any network to which the computer system 1300 connects.

The main memory 1330 may be random access memory (RAM), or any other dynamic storage device commonly known in the art. The read-only memory 1340 may be any static storage device(s) e.g., but not limited to, a Programmable Read Only Memory (PROM) chips for storing static information e.g., start-up or Basic Input/Output System (BIOS) instructions for the processor 1370. The mass storage device 1350 may be any current or future mass storage solution, which can be used to store information and/or instructions. Exemplary mass storage device 1350 includes, but is not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), one or more optical discs, Redundant Array of Independent Disks (RAID) storage, e.g. an array of disks.

The bus 1320 communicatively couples the processor 1370 with the other memory, storage, and communication blocks. The bus 1320 may be, e.g. a Peripheral Component Interconnect (PCI)/PCI Extended (PCI-X) bus, Small Computer System Interface (SCSI), Universal Serial Bus (USB), or the like, for connecting expansion cards, drives, and other subsystems as well as other buses, such a front side bus (FSB), which connects the processor 1370 to the computer system 1300.

Optionally, operator and administrative interfaces, e.g. a display, keyboard, joystick, and a cursor control device, may also be coupled to the bus 1320 to support direct operator interaction with the computer system 1300. Other operator and administrative interfaces can be provided through network connections connected through the communication port(s) 1360. Components described above are meant only to exemplify various possibilities. In no way should the aforementioned exemplary computer system 1300 limit the scope of the present disclosure.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

### Advantages of the Present Disclosure

The present disclosure provides a network architecture with a gateway acting as a private access connection hub to connect to one or more core networks (CNs).

The present disclosure allows the gateway to be deployed by a third party that connects radio access network (RAN) nodes to the one or more CNs.

The present disclosure provides a gateway-assisted cellular network architecture, where during a mobility scenario, paging is successful only after a successful update is performed on a user equipment (UE) at different levels.

The present disclosure allows the gateway to be provided as a service by any entity other than the RAN and the CN service providers.

The present disclosure enhances the communication system.

The present disclosure facilitates to dynamically manage network requirements using gateway assisted network.

The present disclosure facilitates network upgrades to support 6G communication technology.

The present disclosure optimizes network infrastructure cost.

The present disclosure enhances data security.

The present disclosure facilitates to dynamically allocate a network infrastructure based on user defined requirements.

The present disclosure facilitates to provide on demand telecom infrastructure.

The present disclosure facilitates to improvise paging and tracking area related aspects in communication.

We claim:

1. A system (308), comprising:
one or more processors (314); and
a memory (316) storing instructions that, when executed by the one or more processors (314), cause the system (308) to:
determine a unique User Equipment (UE) context of a UE (312) for each of a first coverage state of the UE (312) and a second coverage state of the UE (312);
dynamically save the determined unique UE context of the UE (312); and
transmit a paging message to a Core Network (CN) (304), wherein the unique UE context is saved at the CN (304) to provide a seamless mobility service to the UE (312).

2. The system (308) of claim 1, wherein the first coverage state corresponds to the UE (312) being within a coverage area provided by the system (308), and wherein the second coverage state corresponds to the UE (312) being outside the coverage area provided by the system (308).

3. The system (308) of claim 1, wherein the gateway node (308) acts as an independent hub for establishing a connection between a Radio Access Network (RAN) node (310) and the CN (304).

4. The system (308) of claim 3, wherein the gateway node (308) specifies radio access capabilities of the RAN node (310) to the UE (312), and wherein the radio access capabilities comprise information related to at least one of a type, band, spectrum, bandwidth, and offsets associated with the RAN node (310).

5. The system (308) of claim 1, wherein the gateway node (308) comprises at least one of a spectrum negotiation capability, a payment capability, a paging and tracking capability, and a security maintenance capability.

6. The system (308) of claim 1, wherein the gateway node (308) and the CN (304) send the paging message to a network node (310) and a core network node (306), respectively, when a download (DL) message is to be delivered from the CN (304) to the UE (312).

7. The system (308) of claim 6, wherein the paging message is sent on completion of a handover between the network node (310) and the core network node (306) via the gateway node (308).

8. A method (1200), comprising:
determining (1202), at a system (308), a unique User Equipment (UE) context of a UE (312) for each of a first coverage state of the UE (312) and a second coverage state of the UE (312);
dynamically saving (1204), at the system (308), the determined unique UE context of the UE (312); and
transmitting (1206), at the system (308), a paging message to a Core Network (CN) (304), wherein the unique UE context is saved at the CN (304) to provide a seamless mobility service to the UE (312).

9. The method (1200) of claim 8, wherein the first coverage state corresponds to the UE (312) being within a coverage area provided by the system (308), and wherein the second coverage state corresponds to the UE (312) being outside the coverage area provided by the gateway node (308).

10. A User Equipment (UE) (312), comprising:
one or more processors; and
a memory operatively coupled to the one or more processors and a system (308), wherein the system(308) is configured to:
determine a unique UE context of the UE (312) for each of a first coverage state of the UE (312) and a second coverage state of the UE (312);
dynamically save the determined unique UE context of the UE (312); and
transmit a paging message to a Core Network (CN) (304), wherein the unique UE context is saved at the CN (304) to provide a seamless mobility service to the UE (312).

11. A non-transitory computer-readable medium comprising processor-executable instructions that cause a processor to:
determine a unique User Equipment (UE) context of a UE (312) for each of a first coverage state of the UE (312) and a second coverage state of the UE (312);
dynamically save the determined unique UE context of the UE (312); and
transmit a paging message to a Core Network (CN) (304), wherein the unique UE context is saved at the CN (304) to provide a seamless mobility service to the UE (312).
